(19) United States
(12) Patent Application Publication
(10) Pub. No.: US 2012/0190237 A1
(43) Pub. Date: Jul. 26, 2012

(54) POWER ELECTRICAL CONNECTOR WITH IMPROVED METALLIC SHELL

(75) Inventor: YU ZHU, Shenzhen (CN)

(73) Assignee: HON HAI PRECISION INDUSTRY CO., LTD., New Taipei (TW)

(21) Appl. No.: 13/225,496

(22) Filed: Sep. 5, 2011

(30) Foreign Application Priority Data
Jan. 25, 2011 (CN) 201120024119.4

(51) Int. Cl. H01R 13/6582; H01R 13/627; H01R 24/68

(52) U.S. Cl. 439/607.19; 439/668; 439/354

(57) ABSTRACT

An electrical connector includes an insulative housing, a pair of terminals and a metallic shell retained in the insulative housing. The insulative housing includes a mating portion defining a first surface, a second surface opposite to the first surface and a front surface connecting the first and second surfaces. A receiving space formed in the mating portion and penetrating through the front surface. The terminals include contact portions extending into the receiving space. The metallic shell includes a first wall extending forwardly, an end wall bending downwardly from a front end of the first wall and a second wall bending rearwardly from a bottom end of the end wall. The first and second walls cover the first and second surfaces of the mating portion respectively. The end wall covers the front surface and defines an opening communicating with the receiving space.

### BACKGROUND OF THE INVENTION

1. Field of the Invention

The present invention relates to an electrical connector, and more particularly to a power electrical connector with improved metallic shell.

2. Description of Related Art

U.S. Patent Application Publication No. 2010/0093222 published on Apr. 15, 2010 discloses an electrical connector including an insulative housing, a plurality of terminals and a metallic shell enclosing the insulative housing. The metallic shell is stamped as a frame-shaped configuration and comprises two ends coupled to each other by riveting. The manufacturing method of the metallic shell is complicated.

Hence, an improved electrical connector with an improved metallic shell are needed to solve the above problem.

### BRIEF SUMMARY OF THE INVENTION

The present invention provides an electrical connector including an insulative housing, a pair of terminals and a metallic shell retained in the insulative housing. The insulative housing includes a mating portion defining a first surface, a second surface opposite to the first surface and a front surface connecting the first and second surfaces. A receiving space formed in the mating portion and penetrating through the front surface. The terminals include contact portions extending into the receiving space. The metallic shell includes a first wall extending forwardly, an end wall bending downwardly from a front end of the first wall and a second wall bending rearwardly from a bottom end of the end wall. The first and second walls cover the first and second surfaces of the mating portion respectively. The end wall covers the front surface and defines an opening communicating with the receiving space.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical connector assembly with a first connector separated from a second connector in accordance with an embodiment of the present invention;

FIG. 2 is another perspective view of the electrical connector assembly with the first connector separated from the second connector;

FIG. 3 is an exploded view of the first connector as shown in FIG. 1; and

FIG. 4 is an exploded view of the second connector as shown in FIG. 1.

### DETAILED DESCRIPTION OF THE PREFERRED EMBODIMENT

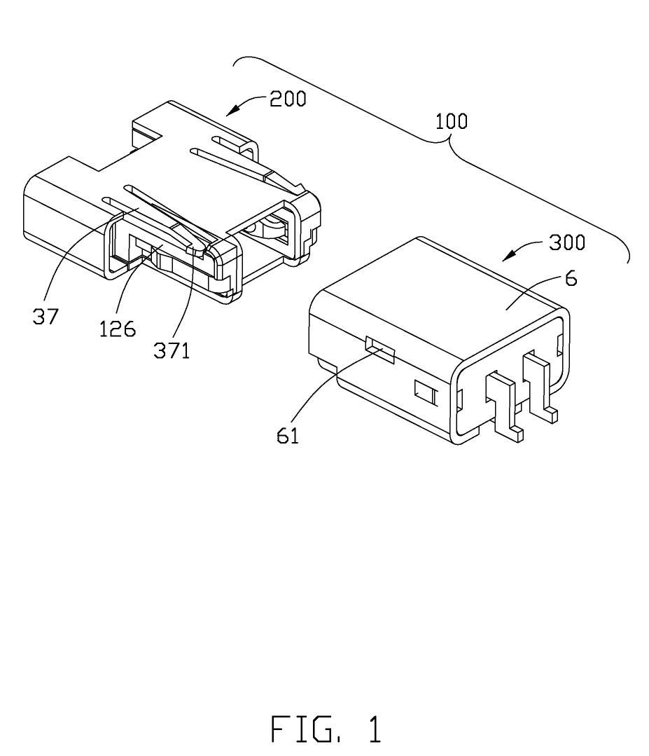

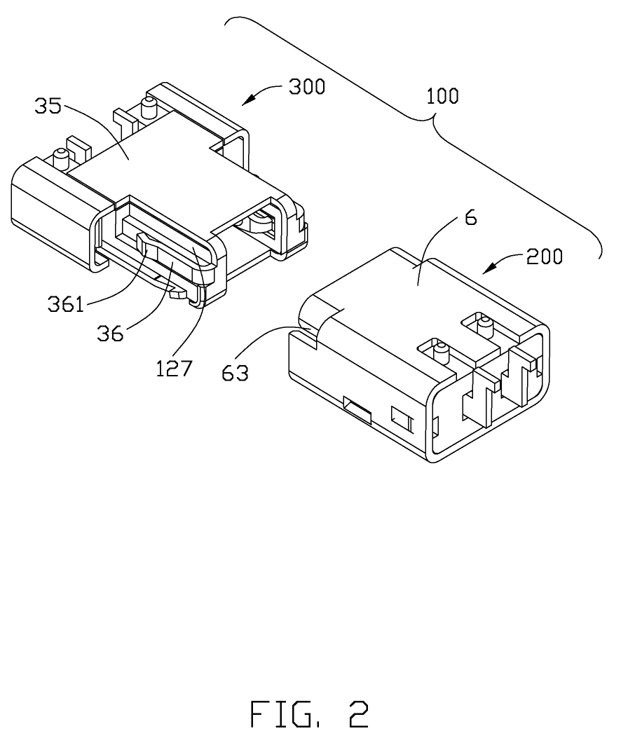

Reference will now be made to the drawing figures to describe the preferred embodiment of the present invention in detail. FIGS. 1 to 2 illustrate an electrical connector assembly 100 including a first connector 200 and a mateable second connector 300.

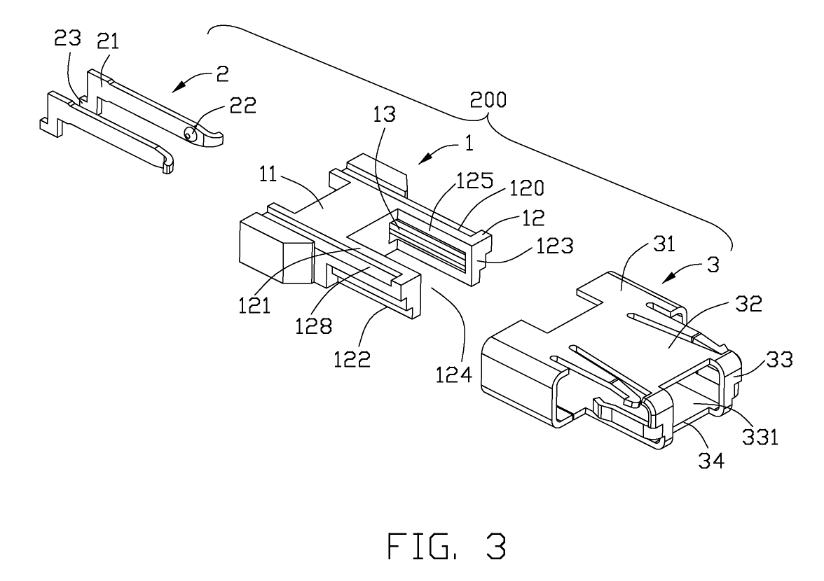

As shown in FIG. 3, the first connector 200 includes a first insulative housing 1, a pair of first terminals 2 retained in the first insulative housing 1 and a metallic shell 3 enclosing the first insulative housing 1. The first insulative housing 1 comprises a body portion 11 and a mating portion 12 extending forwardly from the body portion 11. The mating portion 12 defines a first surface 121, a second surface 122 opposite to the first surface 121 and a front surface 123 connecting the first surface 121 with the second surface 122. A receiving space 124 is formed in the mating portion 12 of the housing 1 and penetrates through the first surface 121, the second surfaces 122 and the front surface 123 so as to form two separate beam portions 120. Each first terminal 2 comprises a retention portion 21, an elastic contact portion 22 extending forwardly from one end of the retention portion 21 and a tail portion 23 extending rearwardly from the other end of the retention portion 21. The metallic shell 3 comprises a frame portion 31 enclosing the body portion 11, a first wall 32 extending forwardly from an upper edge of the frame portion 31, an end wall 33 bending downwardly from a tip of the first wall 32, a second wall 34 bending rearwardly from a low end of the end wall 33 and a soldering portion 35 extending rearwardly from a rear end of the second wall 34. The frame portion 31 is frame-shaped configuration and defines a channel running through a bottom wall thereof so as to receive the soldering portion 35. The soldering portion 35 projects beyond the bottom wall of the frame portion 31 to be soldered on a PCB (not shown). The first and second walls 32, 34 cover the corresponding first and second surfaces 121, 122. The end wall 33 is located at the front surface 123 and defines an opening 331 communicating with the receiving space 124.

As shown in FIG. 3, the two beam portions 120 define two opposite inner faces 125 facing toward each other. Two passageways 13 are respectively formed in the inner faces 125 and penetrating through the body portion 11 of the insulative housing 1 along a front-to-back direction. The two passageways 13 communicate with the receiving space 124. The two first terminals 2 are respectively retained in the corresponding passageways 13. The elastic contact portions 22 of the terminals 2 extend beyond the corresponding inner faces 125 and are received in the receiving space 124.

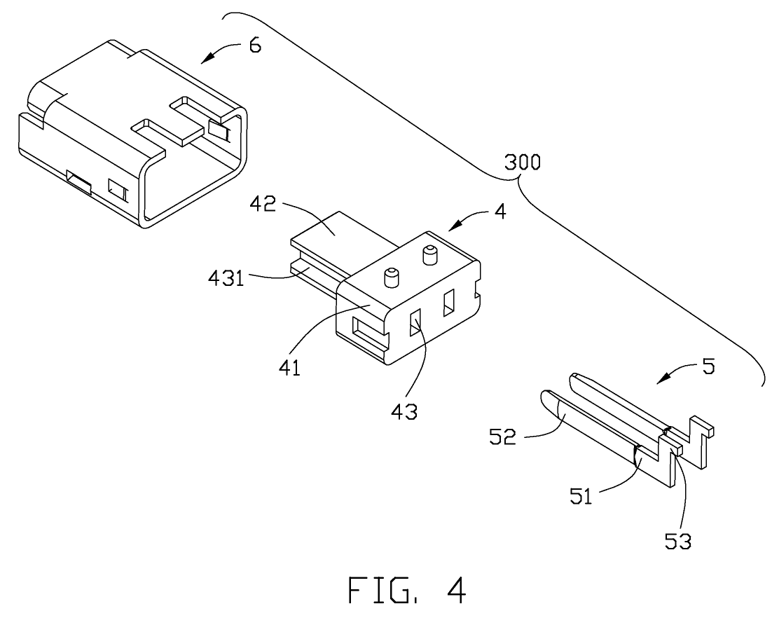

As shown in FIG. 4, the second connector 300 comprises an second insulative housing 4, a pair of second terminals 5 secured in the second insulative housing 4 and a metal shell 6 enclosing the second insulative housing 4. The second insulative housing 4 comprises a base portion 41 and a tongue portion 42 extending from the base portion 41. Two passageways 43 penetrate through the base portion 41 and two side surfaces of the mating portion 42 to form two guide grooves 431. The second terminal 5 comprises a retention section 51 retained in the base portion 41, a planar contact section 52 extending from one end of the retention section 51 and a tail section 53 extending from the other end of the retention section 51. The contact sections 52 are respectively located in the guide grooves 431 and abut against inner surfaces of the guide grooves 431. When the two electrical connectors mate with each other, the mating portion 42 of the insulative housing 4 is received in the receiving space 124, and the contact portions 22 are guided to contact the contact sections 52.

As shown in FIG. 1, the mating portion 12 of the insulative housing 1 defines a pair of outer surfaces 126. The metallic shell 3 further comprises a pair of latch arms 37 extending from the upper edge of the frame portion 31 and located at two sides of the first wall 32. Each latch arm 37 comprises a latch portion 371 formed at its tip thereof. The first surface 121 of the mating portion 12 defines a pair of recesses 128 below the corresponding latch arms 37 to receive the tips of the latch arms 37. Thus, the tips of the latch arms 37 are lower than the first wall 32. The metal shell 6 defines a pair of holes 61 adapted to lock with the latch portions of the latch arms 37. Combination with FIG. 2, the metallic shell 3 further comprises a pair of grounding portions 36 extending rearwardly from two sides of the end wall 33. The grounding portions 36 are parallel to the first and second walls 32, 34 and located adjacent to the second wall 34. Furthermore, each grounding portion 36 defines a protrusion 361 which is formed at a tip thereof and projects beyond the outer surface 126. When the two electrical connectors mate with each other, the protrusions 361 abut against an inner face of the metal shell 6 so as to perform grounding function.

As shown in FIGS. 2 and 4, a bottom side of the metal shell 6 define a pair of elastic offset portions 63 extending into the receiving room thereof. The second surface 122 of the mating portion 12 defines a pair of recesses 127 to engage with the elastic portions 63 so as to avoid misalignment.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector comprising:
an insulative housing comprising a mating portion defining a first surface, a second surface opposite to the first surface and a front surface connecting the first and second surfaces, a receiving space formed in the mating portion and penetrating through the front surface;
a pair of terminals comprising contact portions extending into the receiving space; and
a metallic shell comprising a first wall extending forwardly, an end wall extending downwardly from a front end of the first wall and a second wall extending rearwardly from a bottom end of the end wall, the first and second walls covering the first and second surfaces of the mating portion respectively, the end wall covering the front surface and defining an opening communicating with the receiving space.

2. The electrical connector as claimed in claim 1, wherein the insulative housing further comprises a base portion, the mating portion extends from the base portion, the receiving space penetrates through the first and second surfaces of the mating portion to form two separate beam portions.

3. The electrical connector as claimed in claim 2, wherein the two beam portions define opposite inner faces facing toward each other, two passageways penetrate through the base portion and the inner faces of the tongue portions along a front-to-back direction, the contact portions of the terminals extend beyond the corresponding inner faces and received in the receiving space.

4. The electrical connector as claimed in claim 2, wherein the metallic shell further comprises a frame portion enclosing the base portion, the first wall extends forwardly from an upper edge of the frame portion.

5. The electrical connector as claimed in claim 4, wherein a metallic shell further comprises a soldering portion extending rearwardly from a rear end of the second wall, the frame portion defines a channel running through a bottom wall thereof so as to receive the soldering portion, the soldering portion projects beyond the bottom wall of the frame portion.

6. The electrical connector as claimed in claim 4, wherein the metallic shell further comprises a pair of latch arms extending from an upper edge of the frame portion and located at two sides of the first wall, each latch arm comprises a latch portion formed at its tip thereof.

7. The electrical connector as claimed in claim 6, wherein the first surface of the mating portion defines a pair of recesses adapted to receive tips of the latch arms.

8. The electrical connector as claimed in claim 1, wherein the metallic shell further comprises a pair of grounding portions extending rearwardly from two sides of the end wall to perform grounding function.

9. An electrical connector assembly comprising:
a first electrical connector defining a mating port with an opening forwards receiving room configured by a first insulating housing and a first metallic shell and comprising a pair of first terminals with contacting portions exposing to the receiving room;
a second electrical connector mateable with the first electrical connector, the second electrical connector defining a tongue portion enclosing by a second metallic shell and comprising a pair of second terminals with contacting portions located at opposite ends of the tongue portion;
wherein the two pairs of contacting portions contact with each other when the tongue portion is inserted in the receiving room and the second metallic shell encloses the mating port of the first electrical connector;
wherein the contacting portions of the first and the second terminals are disposed perpendicular to the tongue portion

10. The electrical connector assembly as claimed in claim 9, wherein the first metallic shell defines a pair of latching arm slit therefrom and disposed substantially parallel to the tongue portion to lock with the second metallic shell.

11. The electrical connector assembly as claimed in claim 9, wherein the first metallic shell defines a pair of grounding portions bending therefrom and disposed perpendicularly to the tongue portion.

12. The electrical connector assembly as claimed in claim 11, wherein the first insulating housing defines a pair of separated beam portions in which the contacting portions are located at inner sides of the beam portion and the grounding portions are located at outer sides of the beam portion.

13. The electrical connector assembly as claimed in claim 9, wherein the first metallic shell comprises a pair of upper and lower base portions enclosing the beam portions and exposing to the receiving room in a direction perpendicular to the tongue portion and a pair of end portions covering on front faces of the beam portions.

14. An electrical connector assembly comprising:
a first connector including:
an insulative housing defining, in a front-to-back direction, a rear body potion, and a front mating portion with a receiving space therein under condition that the body portion is dimensioned larger than the mating portion in a transverse direction perpendicular to said front-to-back direction;
a plurality of first contacts disposed in the housing;
a metallic shell snugly enclosing the housing and covering most exterior surfaces of the housing; wherein
said shell unitarily defines a pair of forward resilient latches which primarily lie in a plane defined by a top wall of the shell.

15. The electrical connector assembly as claimed in claim 14, wherein the housing defines a pair of recesses accommodating the corresponding latches.

16. The electrical connector assembly as claimed in claim 14, wherein the shell further includes a pair of resilient grounding arms extending rearwardly from a front end wall of the shell.

17. The electrical connector assembly as claimed in claim 16, wherein said shell further including a bottom wall opposite to the top wall in a vertical direction perpendicular to said front-to-back direction and said transverse direction under condition that the front end wall is unitarily linked between the top wall and the bottom wall to commonly define a U-shaped structure thereof.

18. The electrical connector assembly as claimed in claim 14, further including a second connector, said second connector including an insulative body enclosed by a metallic shield and equipped with a plurality of second contacts, wherein the shield defines a mating cavity to receiving the front mating portion and a pair of holes beside the mating cavity to receive the corresponding latches, respectively.

19. The electrical connector assembly as claimed in claim 18, wherein the shield defines a pair of offset portions on a front rim region thereof to transversely confront and be directly received in another pair of recesses of the insulative housing of the first connector.

20. The electrical connector assembly as claimed in claim 14, wherein the shell further includes a front end wall and a bottom wall under condition that the front end wall is unitarily linked between the top wall and the bottom wall to commonly define a U-shaped structure thereof, and wherein the housing defines a pair of mounting posts extending from a level above the bottom wall downwardly toward and further below the bottom wall.
